(19) United States
(12) Patent Application Publication
(10) Pub. No.: US 2008/0302601 A1
(43) Pub. Date: Dec. 11, 2008

(54) LIFT ASSEMBLY

(76) Inventor: Andrew Baker, Callao, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/758,876

(22) Filed: Jun. 6, 2007

(51) Int. Cl. E06C 5/00

(52) U.S. Cl. 182/69.4; 182/127

(57) ABSTRACT

A portable lift assembly that moves between a retracted position and an extended position when operatively connected with a drive mechanism. The portable lift assembly comprises a first telescoping assembly, a second telescoping assembly, a support assembly and a pulley assembly. The first telescoping assembly has a first stationary leg and a first movable leg, the first movable leg being movable with respect to the first stationary leg. The second telescoping assembly has a second stationary leg and a second movable leg. The second movable leg is movable with respect to the second stationary leg, wherein the support assembly slidably engages with the second movable leg. The pulley assembly operatively connects to the first telescoping assembly and to the support assembly wherein the pulley assembly, when activated by the drive mechanism, simultaneously moves the first movable leg and the support assembly from the retracted position to the extended position to raise the platform to an elevated position.

### CROSS-REFERENCE TO RELATED APPLICATIONS

Not Applicable

### STATEMENT REGARDING FEDERALLY SPONSORED RESEARCH

Not Applicable.

### BACKGROUND OF THE DISCLOSURE

The present disclosure relates to a portable lift assembly that elevates a platform, and in particular, to a lift assembly that telescopically moves the platform such as a hunting stand between a retracted position and an extended position to elevate the platform.

In hunting, photographing, or watching wildlife, an elevated position offers many advantages. First, being elevated above sight lines of the wildlife allows the sportsman to be positioned beyond the eyes of the wildlife to prevent the wildlife from being spooked by the sportsman. Further, the elevated position allows the sportsman to have a vantage point for better and broader observation into the brush and other wildlife habitat. Additionally, the elevated position allows the scent of the sportsman to be carried above and beyond the sense of smell of the wildlife to prevent the wildlife from being spooked by the sportsman. Still further, the elevated position keeps the sportsman out of the line of fire toward other sportsman as projectiles such as bullets and arrows will travel less distance if shot down toward the ground than if shot in a standing position.

Sportsmen prefer the use of stands, scaffolds, and the like to elevate themselves. When the stand is permanently erected at the desired location, continued exposure to weather conditions can cause rust or deterioration at a significantly increased rate. Additionally, since some built-in platforms are not allowed in many areas and must naturally remain at the same location, sportsmen use portable stands. Sportsmen use portable devices in the woods and other habitat far from motor vehicle accessibility. Sportsmen prefer portable devises because when a stand is left unattended, it can be vandalized or stolen.

Current portable devices have certain disadvantages. For example, some current portable devices connect to a tree. Accordingly, these portable devices require that the tree have no limbs to the desired height. Additionally, some current portable devices use unwieldy and bulky linkage members to erect a support or scaffold for the elevated stand. These portable devices require manual handling and installation using specific equipment and tools to assemble such structures. Accordingly, these portable devices require assembly at the desired location. Sportsmen, however, require wildlife stands/platforms that conveniently travel and set up as one assembly.

### SUMMARY

The present disclosure relates to a portable lift assembly that elevates a platform that telescopically moves the platform between a retracted position and an extended position. The portable lift assembly is removably connectable to a vehicle so as to arrive at a desired location in an assembled and ready to use form. The portable lift assembly comprises a first telescoping assembly, a second telescoping assembly, a support assembly and a pulley assembly.

The first telescoping assembly has a first stationary leg and a first movable leg, the first movable leg being movable with respect to the first stationary leg. The second telescoping assembly has a second stationary leg and a second movable leg. The second movable leg is movable with respect to the second stationary leg, wherein the support assembly slidably engages with the second movable leg.

The pulley assembly operatively connects to the first telescoping assembly and to the support assembly wherein the pulley assembly, when activated by a drive mechanism, simultaneously moves the first movable leg and the support assembly from the retracted position to the extended position to raise the platform to an elevated position.

### BRIEF DESCRIPTION OF THE SEVERAL VIEWS OF THE DRAWINGS

In the accompanying drawings which form part of the specification:

FIG. 1 is a side elevational view of a lift assembly constructed in accordance with and embodying the present disclosure illustrating, in a retracted position, a first telescoping assembly, a second telescoping assembly and a support assembly in a retracted position and further illustrating the lift assembly operatively connected to a vehicle winch assembly;

FIG. 2 is a side elevational view of the lift assembly of FIG. 1 illustrating a person remotely activating the vehicle winch assembly to raise the first telescoping assembly, the second telescoping assembly and the support assembly from the retracted position;

FIG. 3 is a side elevational view of the lift assembly of FIG. 2 raised to an extended position to elevate the platform assembly;

FIG. 4 is a partial perspective view of a first movable leg and a second stationary leg of the first telescoping assembly of FIG. 1 and further illustrating a pulley and cable connected to an internal bar of the first movable leg;

FIG. 5 is partial side elevational view of the first telescoping assembly and the second telescoping assembly of FIG. 1 further illustrating additional pulleys and cables; and

FIG. 6 is a side elevational view of the lift assembly illustrating the lift assembly operatively connected to a drive mechanism and illustrating the lift assembly elevating a housing.

Corresponding reference numerals indicate corresponding parts throughout the several figures of the drawings.

### DESCRIPTION OF THE PREFERRED EMBODIMENT

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

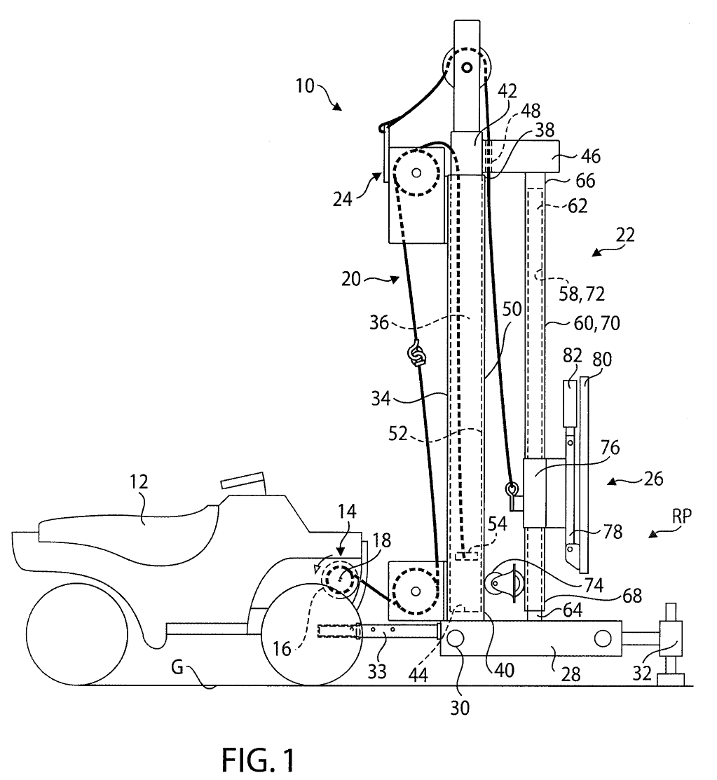

Referring to the drawings, a lift assembly generally shown as 10 of the present disclosure is shown operatively connected to a vehicle 12 having a winch assembly 14 (FIG. 1). The vehicle 12 may be of any type vehicle suitable for use in outdoor activities including, but not limited to, trucks, tractors, trailers, and three or four-wheel, all-terrain vehicles. In the embodiment shown, vehicle 12 is a four-wheel, all-terrain vehicle. The winch assembly 14 comprises a remotely controlled and motorized winch. The winch assembly 14 includes a winch drum 16 mounted around a rotating shaft 18. A motor (not shown) drives the shaft 18 to rotate the winch drum 16 in clockwise and counterclockwise directions.

The lift assembly 10 comprises a first telescoping assembly generally shown as 20, a second telescoping assembly generally shown as 22, a pulley assembly generally shown as 24, and a support assembly generally shown as 26. A base 28 of the lift assembly 10 supports the first telescoping assembly 20 and the second telescoping assembly 22. The base 28 further includes lifting handles 30 to allow the user to grasp or move the lifting assembly 10. As shown, the base 28 may connect with the support device 32 such as, but not limited to, a hydraulic jack. A connector 33 such as a hitch connects the lift assembly 10 to the vehicle 12 such that the base 28 suspends above the ground G. In an embodiment, the connector 33 fastens to the front of the vehicle 12 along an axis of the center of gravity of the vehicle 12. As shown in FIG. 1, the support device 32 adjusts to contact the ground G while supporting the suspended base 28.

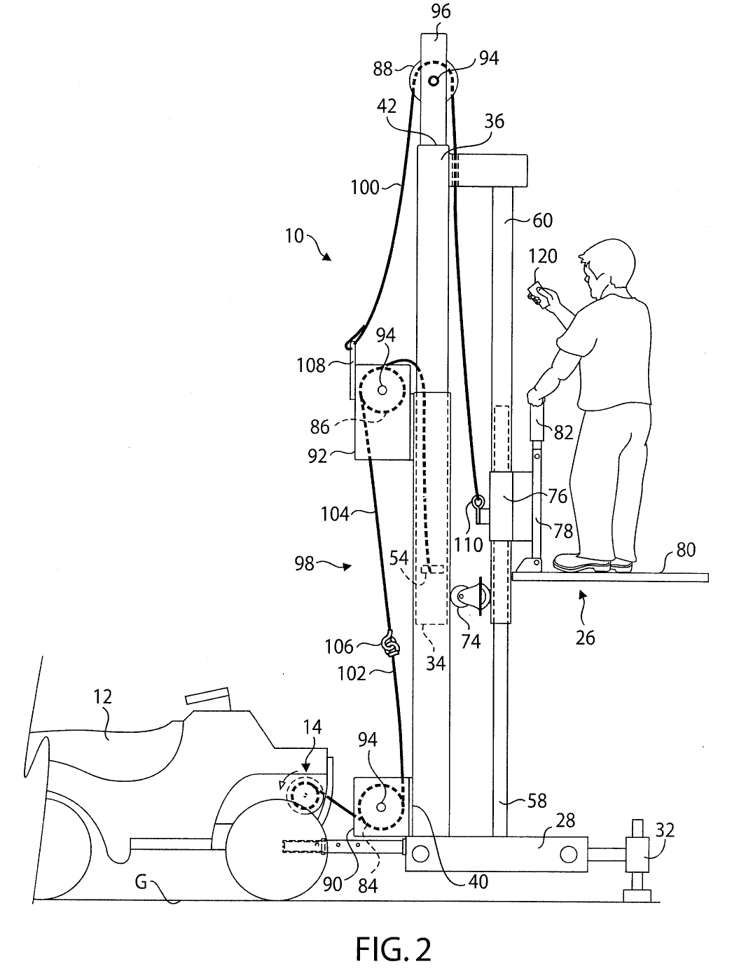

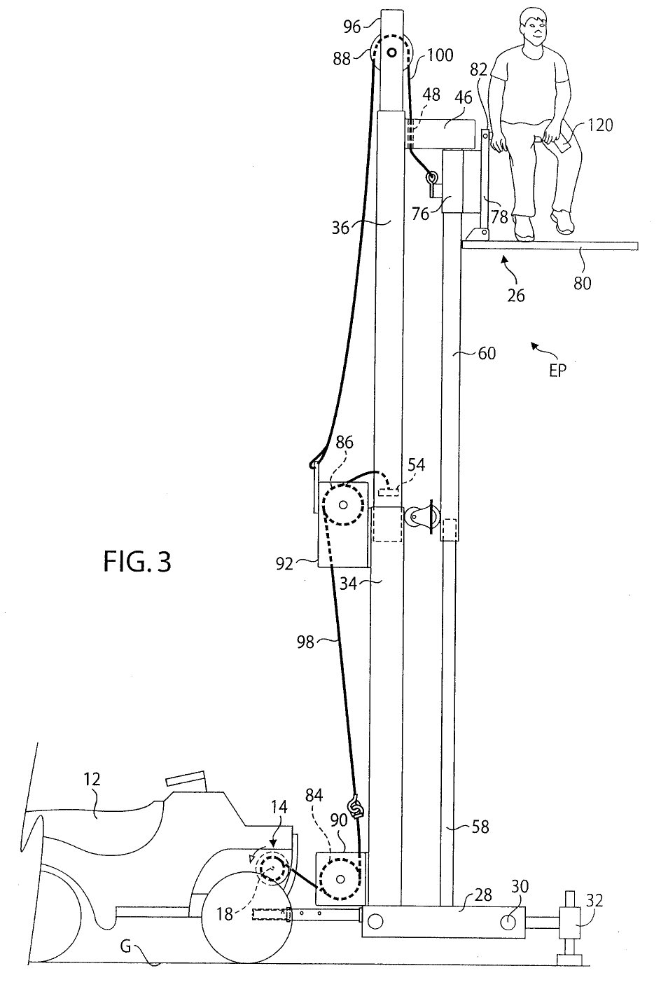

The first telescoping assembly 20 has a first stationary leg 34 and a first movable leg 36, wherein the first movable leg 36 is movable with respect to the first stationary leg 34. In particular, the first movable leg 36 telescopically positions within the first stationary leg 34. In an embodiment, the first stationary leg 34 and the first movable leg 36 comprise channel structures. Each of the first stationary leg 34 and the first movable leg 36 has upper ends 38, 42 and lower ends 40, 44. The upper end 42 of the first movable leg 36 includes an arm 46 that extends outward and toward the second telescoping assembly 22. The arm 46 further includes an aperture 48 defined therethrough as will be discussed. Outer walls 50 of the first movable leg 36 are sized and shaped to fit within inner walls 52 of the first stationary leg 34 so that the first movable leg 36 telescopically moves within (FIG. 1) and beyond (FIGS. 2 and 3) the first stationary leg 34.

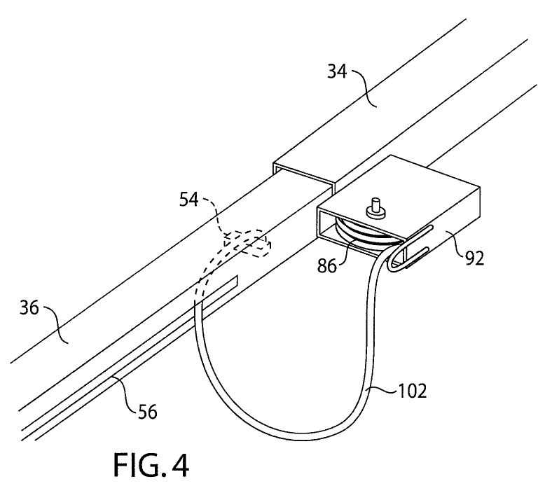

As shown in FIG. 1, the first movable leg 36 includes an internal bar 54. The internal bar 54 is fixed near the lower end 44 of the first movable leg 36 and preferably travels across the entire length between the internal walls of the first movable leg 36. The first movable leg 36 also includes a groove 56 (FIG. 4) positioned between the upper and lower ends 42, 44 of the first movable leg 36. The groove 56 extends substantially the entire length of the first movable leg 36. The lower end of the groove 56, however, is positioned on the first movable leg 36 at point above the internal bar 54.

Returning to FIG. 1, the second telescoping assembly 22 is positioned on the base 28 in a parallel relationship with respect to the first telescoping assembly 20. The second telescoping assembly 22 has a second stationary leg 58 and a second movable leg 60, wherein the second movable leg 60 is movable with respect to the second stationary leg 58. In particular, the second movable leg 60 telescopically positions within the second stationary leg 58. In an embodiment, the second stationary leg 58 and the second movable leg 60 comprise channel structures. Each of the second stationary leg 58 and the second movable leg 60 has upper ends 62, 66 and lower ends 64, 68. Outer walls 70 of the second movable leg 60 are sized and shaped to fit within inner walls 72 of the second stationary leg 58 so that the second movable leg 60 telescopically moves within (FIG. 1) and beyond (FIGS. 2 and 3) the second stationary leg 58.

The second movable leg 60 also includes an attached castor 74 that contacts the outer wall 50 of the first stationary leg 34. This castor 74 is positioned near the lower end 68 of the second movable leg 60. At the upper end 66 of the second movable leg 60, the second movable leg 60 connects with the first movable leg 36 near an end of the arm 46.

In an embodiment, the first telescoping assembly 20 and the second telescoping assembly 22 comprise channel iron. In another embodiment, the first telescoping assembly 20 and the second telescoping assembly 22 comprise other materials such as, but not limited to, alloys, plastics and composites. Still further, in an embodiment, the first and second stationary legs 34, 36 and first and second movable legs 58, 60 have height ranges from about five feet to about fifteen feet.

Still referring to FIG. 1, the support assembly 26 slidably engages with the second movable leg 60. As shown, the support assembly 26 comprises a collar 76 that slides around the second movable leg 60. Accordingly, the internal configuration of the collar 76 matches the configuration of the outer walls 70 of the second movable leg 60 so as to allow the collar 76 to travel along the second movable leg 60. The support assembly 26 further comprises a platform 78 attached to the collar 76. In an embodiment, the platform comprises a hinged foot stand 80 and a hinged seat 82. The foot stand 80 and seat 82 are rotateable between a closed position (FIG. 1) and an open position (FIG. 3). Still further, in an embodiment, the platform 78 removeably attaches to the collar 76. In this embodiment, a plurality of platforms may be interchangeable as required by the user. For example, the platform 78 may include a variety of weight limits and floor configurations such as a grate floor or a solid floor.

Turning to FIG. 2, the pulley assembly 24 comprises a plurality of pulleys and associated mountings/housings for the pulleys. Additionally, the pulley assembly 24 comprises a plurality of cables. In the embodiment shown, the pulley assembly 24 comprises a first pulley 84, a second pulley 86 and a third pulley 88. The housings 90, 92 for the first pulley 84 and the second pulley 86 include enclosures that have a rotateable shaft 94 that suspends the first pulley 84 and the second pulley 86 in the respective housings 90, 92. The housings 90, 92 include appropriate openings for the cables to enter in and out of the housings 90, 92 as will be discussed.

As shown in FIG. 2, the first housing 90 mounts the first pulley 84 near the lower end 40 of the first stationary leg 34. The second housing 92 mounts the second pulley 86 near the upper end 38 of the first stationary leg 34. The housings 90, 92 rotateably fix the first pulley 84 and the second pulley 86 to the respective locations on the first stationary leg 34. A third housing 96, in the form of a support frame, mounts the third pulley 88 to the upper end 42 of the first movable leg 36. As shown, the third housing 96 mounts the third pulley 88 collinear with the first movable leg 36.

The cables of the pulley assembly 24 comprise a first cable generally shown as 98 and a second cable 100. With respect to the first cable 98, an end of the first cable 98 attaches to the winch drum 16 of the winch assembly 14.

The first cable 98 then enters through the first housing 90 and within the groove of the first pulley 84. As shown in FIG. 2, the first cable 98 runs on the underside of the first pulley 84. The first cable 98 exits the first housing 90 and enters the second housing 92. Within the second housing 92, the first cable 98 runs within the groove of the second pulley 86. As shown, the first cable 98 runs on the upper side of second pulley 86. The first cable 98 then exits the second housing 92 and enters the first movable leg 36 via the groove 56 (FIG. 4). The other end of first cable 98 connects with the first movable leg 36 by attaching to the internal bar 54 of the first movable leg 36.

In an embodiment, the first cable 98 may comprise two portions 102, 104 that connect together by a fastener 106 such as a hook and loop fastener (FIG. 2). In this embodiment, the first cable 98 is segmented into the portions 102, 104 to allow one portion to remain fastened to the winch drum 16 and the other portion to remain fastened to the internal bar 54. Accordingly, the lift assembly 10 conveniently separates from the winch assembly 14.

With respect to the second cable 100, an end of the second cable 100 attaches to the second housing 92. In an embodiment, the second cable 100 attaches to a fastener 108 such as an eye bolt that connects with the second housing 92. The second cable 100 then turns upward toward and within the groove of the third pulley 88. As shown in FIG. 2, the second cable 100 runs on top of the third pulley 88. The second cable 100 exits the third pulley 88 and runs downward toward and through the aperture 48 of the arm 46 of the first movable leg 36. The other end of the second cable 100 then fastens to the collar 76 of the support assembly 26. In an embodiment, the other end of the second cable 100 attaches to a fastener 110 such as an eye bolt that connects to the collar 76 of the support assembly 26.

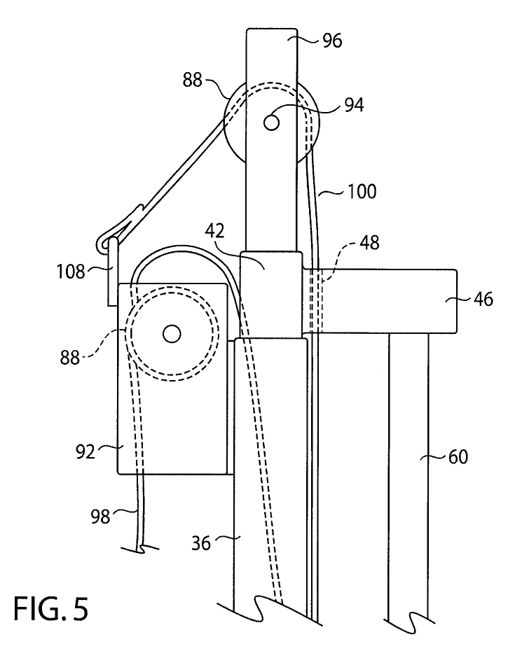

As shown in FIG. 5, the aperture 48 defined through the arm 46 of the first movable leg 36 positions the second cable 100 away from the first movable leg 36 and the second movable leg 60. Additionally, the aperture 48 guides the second cable 100 toward the support assembly 26 FIG. 2) and positions the second cable 100 away from the second movable leg 60. Accordingly, the positions of the third pulley 88 and the aperture 48 minimize or prohibit contact between the second cable 100 and the first movable leg 36, the first stationary leg 34 and the second movable leg 60.

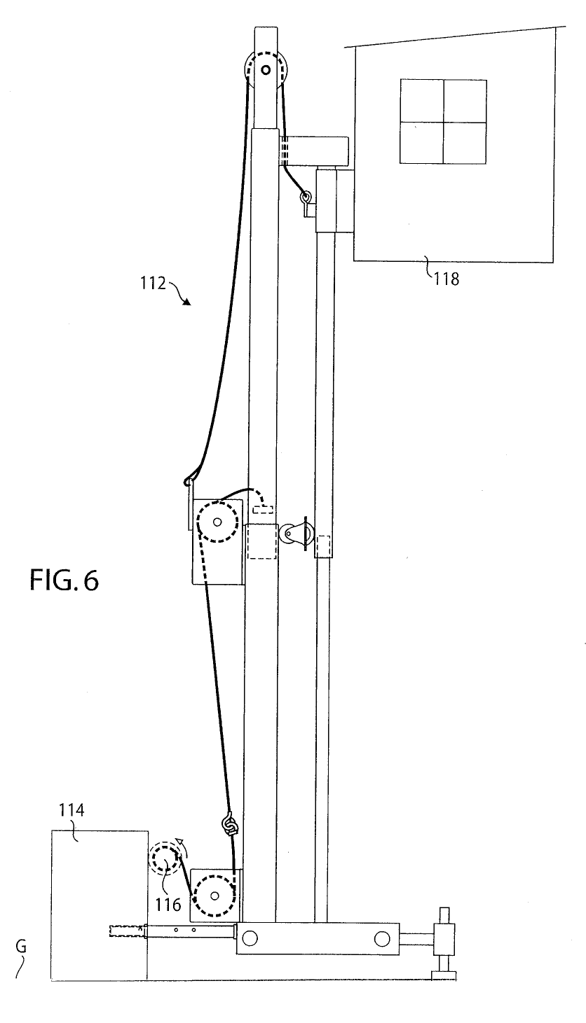

Turning to FIG. 6, another embodiment of a lift assembly 112 of the present disclosure is shown. In this embodiment, lift assembly 112 operatively connects with a drive mechanism 114 having a winch assembly 116. The drive mechanism 114 comprises a stand-alone unit that drives the winch assembly 116. In one embodiment, the stand-alone drive mechanism 114 comprises a power source (not shown) such as a battery and motor (not shown) that drives the rotating shaft for the winch assembly 116. In another embodiment, the stand-alone drive mechanism 114 comprises a hand driven assembly that drives the rotating shaft of the winch assembly 116. Further, as shown in FIG. 6, the support assembly 118 comprises a housing such as a hunter's blind.

Returning to FIGS. 1-5, during operation, the user slides the first movable leg 36 into the first stationary leg 34 and slides the second movable leg 60 into the second stationary leg 58 in order to compress the lift assembly 10 into the retracted position RP. In the retracted position RP, the user grasps the handles 30 extending from the base 28 and connects the lift assembly 10 to the vehicle 12 via the hitch 33. In this position, the base 28 and retracted support jack 32 suspend above the ground G. Since the connected lift assembly 10 suspends above the ground G, the user easily drives the vehicle 12 and connected lift assembly 10 to the desired location. After driving the lift assembly 10 to the desired location, the user engages the support jack 32 with the ground G. The base 28 remains connected to the vehicle 12 and suspended above the ground G. Accordingly, the lift assembly 10 arrives at the desired location in an assembled and ready to use form.

Upon securing the base 28 with the support jack 32, the user pulls the end of the first portion 102 of the first cable 98 out from the winch drum 16 to feed the cable portion 102 through the first housing 90 and within the first pulley 84. The user then pulls the first portion 102 out of the first housing 90 and fastens the first portion 102 with the second portion 102 of the first cable 98 via the fastener 106. The second portion 104 of the first cable 98 fits within the groove of the second pulley 86 and connects with the internal bar 54 of the first movable leg 36. The groove 56 of the first movable leg 36 is wide enough to allow the first cable 98, and in particular the second portion 102 of the first cable 98, to pass through and connect with the internal bar 54.

As shown in FIG. 1, the support assembly 26 is positioned near the ground G. After operatively connecting the lift assembly 10 to the remotely controlled and motorize winch assembly 14 by fastening together the first cable 98 and the second cable 100, the user steps on the platform 78 and transmits a signal from a remote control 120 (FIG. 2). A receiver (not shown) of the winch assembly 14 receives the signal, and in response, communicates to a motor controller (not shown) to actuate the winch motor in order to rotate the rotating shaft 18 of the winch drum 16 in the counterclockwise direction.

Since the first cable 98 initially contacts the underside of the first pulley 84, the activated winch drum 16 pulls the first cable 98 between the first pulley 84 and the second pulley 86 in a downward direction. Since the second portion 104 of the first cable 98 positions on the top side of the second pulley 86 and connects with the internal bar 54, the second portion 104 of the first cable 98 then telescopically pulls the first movable leg 36 upward and out toward the upper end 38 of the first stationary leg 34 (FIG. 2). As the first movable leg 36 travels out of the first stationary leg 34, the groove 56 moves around the first cable 98 as the first movable leg 36 moves between the retracted position RP and the extended position EP.

With the first movable leg 36 telescoping out of the first stationary leg 34, the third pulley 88 moves upward with respect to the first stationary leg 34 as the third housing 96 attaches to the upper end of the first movable leg 36. As shown in FIG. 2, a first end of the second cable 100 is fixed to the second housing 92 which is also fixed to the first stationary leg 34. As the third pulley 88 rises higher with the telescoping first movable leg 36, the other end of the second cable 100 pulls the support assembly 26 upward. The support assembly 26 rises around the second movable leg 60. Since the second movable leg 60 connects with the first movable leg 36 via the arm 46, the second movable leg 60 telescopically moves upward from the second stationary leg 58. As shown in FIG. 2, the caster 74 rolls along the first stationary leg 34 as the second movable leg 60 telescopically moves upward and out from the second stationary leg 58.

As shown in FIG. 3, the user continues this upward movement until the platform 78 reaches the desired height. Therefore, when activated by the winch assembly 14, the lift assembly 10 simultaneously moves the first movable leg 36 and the support assembly 26 from the retracted position RP to the extended position EP to raise the platform 78 to the elevated position. The length of the second cable 100 and legs 34, 36 and 58, 60 prohibit the second movable leg 60 from completely exiting the second stationary leg 58. At the desired height, the user transmits a signal from the transmitter of the remote control 120 to the receiver of the motorized winch assembly 14 to stop the rotating shaft 18. The winch assembly 14 engages a clutch or a brake (not sown) in order to hold the support assembly 26 in the elevated position. In another embodiment (not shown), the user engages a brake between the collar 76 and the second movable leg 60 in order to maintain the platform 78 in the elevated position. Still further, in another embodiment (not shown), the second movable leg 60 and collar 76 may have mating threads that can also lock the platform 78 in the elevated desired position.

When the user wants to move the platform 78 back to the retracted position RP, the user transmits another signal from the remote control 120 to the receiver of the winch assembly 14 which in response disengages the brake or the clutch of the winch assembly 14 in order to lower the platform 78 by the weight of the user and/or by the weight of the platform 78. In response, the first movable leg 36 telescopically retracts within the first stationary leg 34 and the second movable leg 60 telescopically retracts within the second stationary leg 58 to move the lift assembly 10 from the extended position EP to the retracted position RP. Alternatively, in an embodiment, the receiver of the winch assembly 14 commands the rotating shaft 18 to move in the clockwise direction in order to release the tension between first cable 98 and the second cable 100 and control the rotation of the winch drum 16 in the clockwise direction to slowly lower the user and/or the platform 78 near the ground G. At any time during use of the lift assembly 10, the user is free to disengage the support jack 32 from the ground G and move the vehicle 12 and the connected lift assembly 10 to any desired location.

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

Moreover, the use of the terms “upper” and “lower” or “up” and “down” or “retracted” or “extended” and variations of these terms is made for convenience, but does not require any particular orientation of the components.

I claim:

1. A portable lift assembly that moves between a retracted position and an extended position when the portable lift assembly operatively connects with a drive mechanism, the portable lift assembly comprising:
a first telescoping assembly, the first telescoping assembly having a first stationary leg and a first movable leg, the first movable leg being movable with respect to the first stationary leg;
a second telescoping assembly that is connected to the first telescoping assembly, the second telescoping assembly having a second stationary leg and a second movable leg, the second movable leg being movable with respect to the second stationary leg;
a support assembly slidably engaged with the second movable leg; and
a pulley assembly operatively connected to the first telescoping assembly and to the support assembly wherein the pulley assembly, when activated by the drive mechanism, simultaneously moves the first movable leg and the support assembly from the retracted position to the extended position to raise the platform to an elevated position.

2. The lifting assembly of claim 1 wherein the first stationary leg and the first movable leg are channel shaped and each leg has an upper end and a lower end wherein outer walls of the first movable leg fit within inner walls of the first stationary leg such that the first movable leg telescopically moves within and beyond the first stationary leg.

3. The lifting assembly of claim 1 wherein the second stationary leg and the second movable leg are channel shaped and each leg has an upper end and a lower end wherein outer walls of the second movable leg fit within inner walls of the second stationary leg such that the second movable leg telescopically moves within and beyond the second stationary leg.

4. The lifting assembly of claim 1 wherein the upper end of the second movable leg connects with the upper end of the first movable leg to connect the second telescoping assembly to the first telescoping assembly.

5. The lifting assembly of claim 2 wherein the pulley assembly comprises a first pulley, a second pulley, a third pulley and housings that mount the first pulley near the lower end of the first stationary leg and that mount the second pulley near the upper end of the first stationary leg.

6. The lifting assembly of claim 5 wherein the third pulley mounts to the upper end of the first movable leg.

7. The lifting assembly of claim 5 wherein the pulley assembly further comprises a first cable and a second cable.

8. The lifting assembly of claim 7 wherein first cable positions around the first pulley and the second pulley and connects with the drive mechanism and within the first movable leg.

9. The lifting assembly of claim 8 wherein the first movable leg includes an internal bar positioned near the lower end of the first movable leg such that the first cable connects to the internal bar.

10. The lifting assembly of claim 9 wherein the first movable leg has a groove positioned between the upper end and the lower end of the first stationary leg such that the first cable inserts within the groove to the attach to the internal bar.

11. The lifting assembly of claim 10 wherein the groove moves around the first cable as the first movable leg moves from the retracted position to the extended position.

12. The lifting assembly of claim 5 wherein the second cable positions around the third pulley and connects with the housing of the second pulley and with the platform assembly.

13. The lifting assembly of claim 1 further comprising a base wherein the first stationary leg and the second stationary leg attach to the base.

14. In combination with a vehicle having a remotely controlled and motorized winch assembly, a lift assembly comprising:
a first telescoping assembly, the first telescoping assembly having a first stationary leg and a first movable leg, the first movable leg being telescopically positioned within the first stationary leg, the first movable leg having a groove positioned between an upper end and a lower end of the first movable leg and having an internal bar positioned near the lower end;
a second telescoping assembly that is connected to the first telescoping assembly, the second telescoping assembly having a second stationary leg and a second movable leg, the second movable leg being telescopically positioned within the second stationary leg;
a support assembly slidably engaged with the second movable leg, the support assembly having a platform; and
a pulley assembly operatively connected to the remotely controlled and motorized winch assembly, the internal bar of the first movable leg and to the support assembly wherein the pulley assembly, when activated by the remotely controlled and motorized winch assembly, simultaneously moves the first movable leg and the support assembly from the retracted position to the extended position to raise the platform to an elevated position.

15. The lifting assembly of claim 14 wherein the pulley assembly comprises a first pulley, a second pulley, a third pulley and housings that mount the first pulley near a lower end of the first stationary leg and that mount the second pulley near an upper end of the first stationary leg and that mount the third pulley to the upper end of the first movable leg.

16. The lifting assembly of claim 15 wherein the pulley assembly further comprises a first cable and a second cable.

17. The lifting assembly of claim 16 wherein first cable positions around the first pulley and the second pulley and connects with the remotely controlled and motorized winch assembly and with the internal bar of the first movable leg such that the first cable passes through the groove of the first movable leg to connect with the internal bar of the first movable leg.

18. The lifting assembly of claim 16 wherein the second cable positions around the third pulley and connects with the housing of the second pulley and with the platform assembly.

19. The lifting assembly of claim 14 further comprising a remote controlled transmitter that communicates with and operatively controls the remotely controlled and motorized winch assembly.

20. A method of elevating a platform between a retracted position and an extended position, the method comprising:
engaging the platform with a telescoping assembly;
operatively connecting the telescoping assembly with a drive mechanism;
activating the drive mechanism to move the telescoping assembly while simultaneously moving the engaged platform from the retracted position to the extended position to raise the platform to an elevated position.
